(19) United States
(12) Patent Application Publication
(10) Pub. No.: US 2022/0279007 A1
(43) Pub. Date: Sep. 1, 2022

(54) ANALYSIS SYSTEM, METHOD, AND PROGRAM

(71) Applicant: NEC Corporation, Minato-ku, Tokyo (JP)

(72) Inventor: Shunichi KINOSHITA, Tokyo (JP)

(73) Assignee: NEC Corporation, Minato-ku, Tokyo (JP)

(21) Appl. No.: 17/626,204

(22) PCT Filed: Jul. 17, 2019
(86) PCT No.: PCT/JP2019/028085

§ 371 Date: Jan. 11, 2022

(51) Int. Cl. H04L 9/40

(52) U.S. Cl. CPC H04L 63/1433; H04L 63/20

(57) ABSTRACT

An analysis system includes: a configuration information acquisition unit which acquires configuration information from an agent which collects the configuration information of a device by scanning the device included in a system to be diagnosed; a generation unit which generates one or more initial facts which indicates a situation relating to security in the system to be diagnosed or the device based on the configuration information; and an analysis unit which analyzes a flow of an attack which is executable in the system to be diagnosed based on the one or more initial facts.

### TECHNICAL FIELD

The present invention relates to an analysis system, an analysis method, and an analysis program for analyzing information that serves as a basis for making decisions concerning actions against attacks on a system to be diagnosed.

### BACKGROUND ART

Information processing systems that include such as multiple computers are required to take security measures to protect information assets from cyber attacks, and the like. The security measures include diagnosing such as the vulnerability of the target system and removing the vulnerability if necessary, and the like.

A system that is the target of a security diagnose is referred to as a system to be diagnosed. Non Patent Literatures (NPLs) 1-2 describe an asset management system that evaluates the impact of each vulnerability in order to take measures relating to security for the system to be diagnosed, respectively.

The asset management system described in NPLs 1-2 acquires information of the devices included in the system to be diagnosed by scanning the system to be diagnosed. The asset management system described in NPLs 1-2 then uses the acquired information to manage the status relating to security of each device.

### CITATION LIST

### Non Patent Literature

NPL 1: “NEC Cyber Security Platform”, [online], NEC Corporation, [searched on Feb. 28, 2019]

NPL 2: “SKYSEA Client View”, [online], Sky Corporation, [searched on Feb. 28, 2019]

### SUMMARY OF INVENTION

### Technical Problem

As described in NPLs 1-2, each device included in the system to be diagnosed is scanned to collect information on the security of each device to identify the vulnerabilities of each device and the presence or the absence of the attacks that may be executed against each device, and the like. However, if security problems are identified for each device, the impact of the identified security problems on the entire system to be diagnosed may not be understood.

Therefore, it is a principal object of the present invention to provide an analysis system, an analysis method, and an analysis program capable of analyzing security problems where the configuration of the entire system to be diagnosed is taken into account.

### Solution to Problem

An analysis system according to the present invention is an analysis system includes a configuration information acquisition unit which acquires configuration information from an agent which collects the configuration information of a device by scanning the device included in a system to be diagnosed, a generation unit which generates one or more initial facts which indicates a situation relating to security in the system to be diagnosed or the device based on the configuration information, and an analysis unit which analyzes a flow of an attack which is executable in the system to be diagnosed based on the one or more initial facts.

An analysis method according to the present invention is an analysis method includes acquiring configuration information from an agent which collects the configuration information of a device by scanning the device included in a system to be diagnosed, generating one or more initial facts which indicates a situation relating to security in the system to be diagnosed or the device based on the configuration information, and analyzing a flow of an attack which is executable in the system to be diagnosed based on the one or more initial facts.

An analysis program according to the present invention, causing a computer to execute an acquisition process of acquiring configuration information from an agent which collects the configuration information of a device by scanning the device included in a system to be diagnosed, a generation process of generating one or more initial facts which indicates a situation relating to security in the system to be diagnosed or the device based on the configuration information, and an analysis process of analyzing a flow of an attack which is executable in the system to be diagnosed based on the one or more initial facts.

### Advantageous Effects of Invention

According to the present invention, it is possible to analyze security problems where the configuration of the entire system to be diagnosed is taken into account.

### BRIEF DESCRIPTION OF DRAWINGS

FIG. 1 is a block diagram showing an example of the configuration of an analysis server of the first example embodiment of the present invention.

FIG. 2 is an explanatory diagram showing an example of an initial fact generated by a fact generation unit 122.

FIG. 3 is an explanatory diagram showing an example of an attack graph generated by an analysis unit 123.

FIG. 4 is a flowchart showing the operation of the attack graph display processing by the analysis server 100 of the first example embodiment.

FIG. 5 is an explanatory diagram showing an example of the use of a configuration management server and an analysis server of the second example embodiment of the present invention.

FIG. 6 is a block diagram showing an example of each configuration of the configuration management server and the analysis server of the second example embodiment of the present invention.

FIG. 7 is a flowchart showing the operation of the countermeasure instruction processing by the configuration management server 500 and the analysis server 600 of the second example embodiment.

FIG. 8 is a block diagram showing another example of the configuration of the analysis server of the second example embodiment of the present invention.

FIG. 9 is an explanatory diagram showing an example of a hardware configuration of the server according to the present invention.

FIG. 10 is a block diagram showing an overview of an analysis system according to the present invention.

### DESCRIPTION OF EMBODIMENTS

Hereinafter, example embodiments of the present invention are described with reference to the drawings.

### Example Embodiment 1

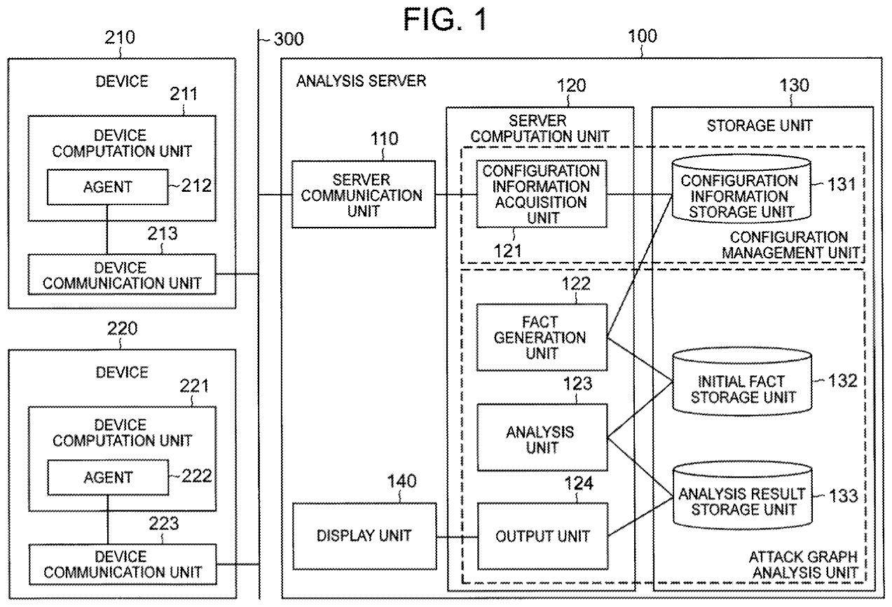

FIG. 1 is a block diagram showing an example of the configuration of an analysis server of the first example embodiment of the present invention. The analysis server 100 of the first example embodiment includes a server communication unit 110, a server computation unit 120, a storage unit 130, and a display unit 140.

The analysis server 100 in this example embodiment is a system for analyzing a situation relating to security of a system to be diagnosed. In each of the following example embodiments, it is assumed that the system to be diagnosed is mainly an IT (Information Technology) system in a company. In other words, in the system to be diagnosed, a plurality of devices are connected through a communication network. The system to be diagnosed is not limited to the above example; for example, it may be a system for controlling an OT (Operational Technology) system.

The devices included in the system to be diagnosed include a personal computer, a server, a switch, a router, and the like. However, the devices included in the system to be diagnosed are not limited to these examples. The system to be diagnosed also includes other type of device connected to a communication network. The device included in the system to be diagnosed may be a physical device or a virtual device.

The device 210, 220 shown in FIG. 1 are examples of devices included in a system to be diagnosed. The number of devices included in the system to be diagnosed is not limited to the example shown in FIG. 1. The number of devices included in the system to be diagnosed is not particularly limited. Also, the analysis server 100 may be one of the devices included in the system to be diagnosed. The analysis server 100 may be set outside the system to be diagnosed in a format such as cloud computing, and may be connected to the system to be diagnosed through a communication network.

The device 210 includes a device computation unit 211 and a device communication unit 213. In addition, the device computation unit 211 includes an agent 212. The device computation unit 211 has a function for executing necessary processing in the device 210. The device computation unit 211 is realized, for example, by a CPU (Central Processing Unit). The function of the agent 212 will be described below.

In the following description, for convenience of explanation, it is assumed that the device 220 has the same function as the device 210. That is, the device computation unit 221, the agent 222, and the device communication unit 223 included in the device 220 have the same functions as the device computation unit 211, the agent 212, and the device communication unit 213 included in the device 210, respectively.

As described below, the analysis server 100 of this example embodiment acquires configuration information from the agents installed in each device, respectively, and uses each acquired configuration information for analyzing attacks.

Next, each component of the analysis server 100 will be described. As shown in FIG. 1, the server computation unit 120 includes a configuration information acquisition unit 121, a fact generation unit 122, an analysis unit 123, and an output unit 124. In addition, the storage unit 130 includes a configuration information storage unit 131, an initial fact storage unit 132, and an analysis result storage unit 133.

The server communication unit 110 has a function of communicating with the device 210, 220 respectively through a communication network 300.

The configuration information acquisition unit 121 acquires configuration information of each device collected by each of the agent 212, 222 in the device 210, 220 through the server communication unit 110.

The agent 212, 222, as an example, collect each configuration information of the device 210, 220 at a predetermined timing and transmit the collected configuration information to the configuration information acquisition unit 121. The predetermined timing includes a predetermined time every day, at startup of the devices, and the like. The predetermined timing may include other timings.

The timing and interval at which the agent 212, 222 collect each configuration information may be determined as appropriate according to the scale of the system to be diagnosed and the specific function of the device 210, and the like. In addition, the agent 212, 222 may collect each configuration information of the device 210, 220 at other timings other than the timings so determined.

The configuration information acquisition unit 121 may instruct the agent 212, 222, respectively, to collect each configuration information of the device 210, 220. The agent 221, 222 may collect each configuration information of the device 210, 220 in response to the instructions.

Further, the timing for collecting each configuration information and the timing for transmitting the collected configuration information to the configuration information acquisition unit 121 may be different. For example, when the device 210, 220 are devices that are not always connected to the communication network 300, such as mobile terminals, the agent 211, 222 collect each configuration information at the timing as described above. Thereafter, when the device 210, 220 are connected to the communication network 300, the agent 211, 222 may transmit the collected each configuration information to the configuration information acquisition unit 121.

Next, the function of the agent 212 will be described. The agent 212 collects configuration information of the device 210 by scanning inside the device 210. The agent 212 may be realized by software. In the case where the agent 212 is realized by software, the desired function is realized by the device computation unit 211 (for example, CPU) operating according to the software that realizes the agent 212. Here, for the sake of convenience, the operation of the device computation unit 211 according to the software that realizes the agent 212 is described as the operation of the agent 212.

The configuration information collected by the agent 212 may include the operating system (OS) installed in the device 210 and the version of the OS, the configuration information of the hardware installed in the device 210, the software installed in the device 210, the version of the software, and the software settings, etc.

The configuration information collected by the agent 212 may include user accounts and account privileges, connected networks and IP (Internet Protocol) addresses, devices connected to the device 210 communicably, communication destination devices communicating with the device 210, and the content of the communication, and CPU model.

Further, the configuration information collected by the agent 212 may include communication data to be exchanged with the communication destination devices of the device 210, information on a communication protocol used for exchanging such communication data, and information indicating a status of a port of the device 210 (which port is open). The communication data includes, for example, information on the transmission source and the transmission destination of the communication data.

The examples of configuration information collected by the agent 212 are not limited to the above examples. The agent 212 may collect, as the configuration information of the device 210, other information that is necessary for analyzing attacks that can be executed on each device. The agent 212 transmits the collected configuration information to the analysis server 100 through the device communication unit 213. The agent 222 also collects the same type of configuration information in the same manner and transmits the configuration information to the analysis server 100 through the device communication unit 223.

The device communication unit 213 has a function of communicating with the analysis server 100 through the communication network 300. The device communication unit 213 transmits configuration information input from the agent 212 to the analysis server 100.

The server communication unit 110 receives each configuration information transmitted from the device 210, 220, respectively. The server communication unit 110 inputs each received configuration information to the configuration information acquisition unit 121.

The configuration information acquisition unit 121 stores each input configuration information in the configuration information storage unit 131. The configuration information storage unit 131 has a function of storing the configuration information. The configuration information stored by the configuration information storage unit 131 is not limited to the information input from the configuration information acquisition unit 121. For example, the configuration information storage unit 131 may store in advance information of a device not shown in the figure that does not have the function of the agent 212.

As shown in FIG. 1, the configuration information acquisition unit 121 and the configuration information storage unit 131 correspond to the configuration management unit that manages the configuration of the system to be diagnosed described above. The function of acquiring the information of the device in the configuration management unit is similar to the function of acquiring the information of the device possessed by the asset management system described in NPL 1 and the like.

The fact generation unit 122 has a function of generating one or more initial facts by referring to the configuration information stored in the configuration information storage unit 131. In the present example embodiment, an initial fact refers to a state mainly related to security in a system to be diagnosed or a device included in the system to be diagnosed, which is described in a format that can be referred to by the analysis unit 123 described below.

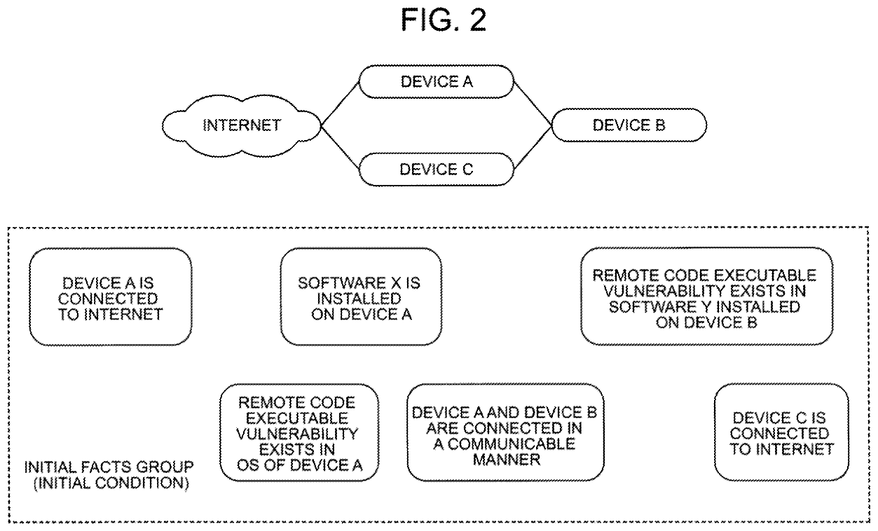

FIG. 2 is an explanatory diagram showing an example of an initial fact generated by the fact generation unit 122. The upper of FIG. 2 shows the system to be diagnosed assumed in this example.

As shown in the upper of FIG. 2, it is assumed that the system to be diagnosed in this example includes a device A, a device B, and a device C. The device A and the device C are connected to the Internet. In addition, the device B is connected to the device A and the device C through a network. Each of the device A, device B, and device C corresponds to the device 210, 220 shown in FIG. 1.

The configuration information acquisition unit 121 acquires configuration information collected by an agent installed in each of the device A, B, and C from each device. Next, the configuration information acquisition unit 121 stores each of the acquired configuration information in the configuration information storage unit 131. The fact generation unit 122 generates an initial fact using the configuration information about each device stored in the configuration information storage unit 131.

The fact generation unit 122, for example, references the OS and OS version installed in a certain device from the configuration information and generates an initial fact representing the situation that the OS of the referenced version is installed in the target device.

Similarly, the fact generation unit 122 may reference certain software and software version installed on a certain device from the configuration information and generate an initial fact representing the situation that the software of the referenced version is installed in the target device.

Alternatively, the fact generation unit 122 may generate an initial fact representing the situation that the first device and the second device are communicatively connected by referring to the second device that is communicatively connected to a certain first device from the configuration information.

The initial fact generated by the fact generation unit 122 is not limited to the above example. The fact generation unit 122 may generate any information included in the configuration information as the initial fact.

The lower of FIG. 2 shows an example of an initial fact generated by the fact generation unit 122 with respect to the system to be diagnosed described above. In the example shown in the lower of FIG. 2, each of the elements represented by the rounded corner rectangle represents one initial fact.

As shown in the lower of FIG. 2, the fact generation unit 122 generates “The device A is connected to the Internet”, “The software X is installed on the device A”, and the like as initial facts. The initial facts to be generated are not limited to the example shown in the lower of FIG. 2, and may be generated as appropriate according to the system to be diagnosed or each device.

The fact generation unit 122 stores the generated one or more initial facts in the initial fact storage unit 132. The initial fact storage unit 132 has a function of storing the initial facts.

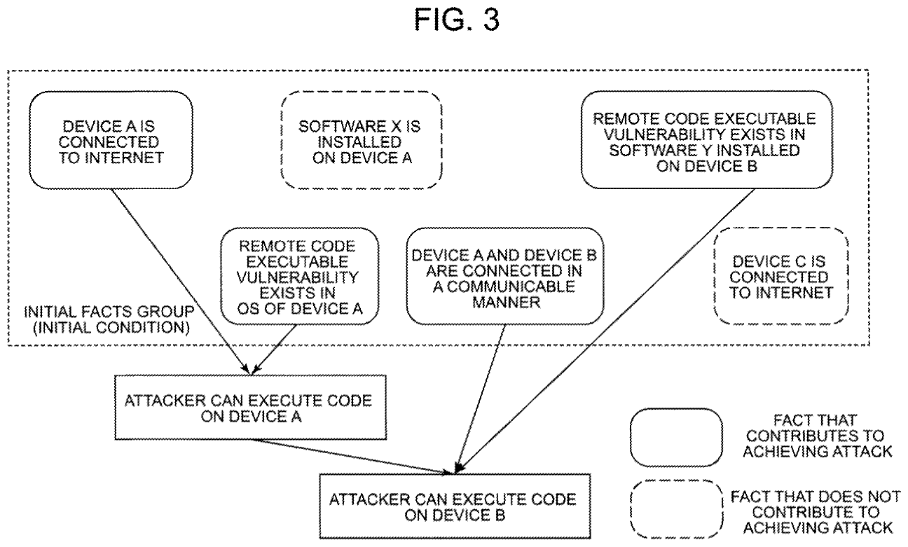

The analysis unit 123 has a function of generating an attack graph based on one or more initial facts stored. FIG. 3 is an explanatory diagram showing an example of an attack graph generated by the analysis unit 123.

The attack graph in this example embodiment is a graph that can represent a flow of an attack that can be executed in the system to be diagnosed. In other words, the attack graph can represent the state such as the presence or absence of vulnerabilities of a certain device, and the relation from attacks that can be executed on a certain device to attacks that can be executed on other device in the system to be diagnosed,

The attack graph is represented as a directed graph in which facts are nodes and the relations between facts are edges. In the attack graph represented as a directed graph, the facts are either the initial facts described above or facts representing attacks that can be executed in each device included in the system to be diagnosed. By generating the attack graph by the analysis unit 123, attacks that may occur in the system to be diagnosed can be analyzed.

When the generated attack graph is used, the attack path representing the series of flow from the initial fact to the fact representing the possibility of an attack can be derived. By using the attack path, it is possible to analyze security events that are difficult to determine by simply scanning individual devices for obtaining vulnerability information, such as the flow of the attack in the system to be diagnosed, devices that require priority countermeasures.

The analysis unit 123, as an example, generates an attack graph using an analysis rule based on one or more initial facts. An analysis rule is a rule for deriving another fact from one or more facts. The analysis rules are predetermined in the analysis server 100.

The analysis unit 123 determines whether the state related to security represented by the initial fact matches the conditions indicated by the analysis rules. If the initial fact matches all the conditions indicated by the analysis rules, the analysis unit 123 derives a new fact. The new fact represents, for example, a content of an attack that can be executed by each device included in the system to be diagnosed.

The derivation of a new fact indicating that an attack is possible indicates that the attack represented by the derived new fact is executable when the device included in the system to be diagnosed is in the state represented by the initial fact used to derive the new fact.

In other words, the fact used to derive the new fact is a precondition for the attack represented by the new fact to become executable.

In addition, another attack may become executable due to the fact that a certain attack is executable. In that case, the analysis unit 123 repeatedly performs the derivation of new facts using the analysis rules with the newly derived facts as preconditions as described above in addition to the initial facts.

The derivation of new facts is performed repeatedly, for example, until no new facts are derived. With the derivation of the new fact, the analysis unit 123 generates an attack graph by using the initial fact or the new fact as a node and connecting the fact including the initial fact, which is a premise of the new fact, to the new fact with an edge.

Hereinafter, a generation example of an attack graph by the analysis unit 123 is described with reference to FIG. 3, specifically. In the system to be diagnosed, it is assumed that the initial facts shown in FIG. 3 have been generated. Also assume that the following relation is predetermined as an analysis rule: “An attacker can execute code on a device connected to the Internet” when “A certain device is connected to the Internet” and “A remote code executable vulnerability exists in the OS of the device connected to the Internet”.

Referring to FIG. 3, it can be seen from the initial facts that all of the conditions of the above analysis rules are satisfied with respect to the device A. Therefore, the analysis unit 123 derives a new fact that “An attacker can execute code on the device A”.

The analysis unit 123 also generates an attack graph that represents an attack path from the initial facts to the derived new fact. Specifically, the analysis unit 123 connects each of the two initial facts to the fact representing the attack with an edge that goes from each of the two initial facts to the fact representing the executable attack.

Next, a generation example of an attack graph by the analysis unit 123 in the case where an attack becomes executable and therefore another attack becomes executable is described.

In the example shown in FIG. 3, it is assumed that the initial fact and the fact that “An attacker can execute code on the device A” are generated. Also assume that the following relation is predetermined as an analysis rule: “An attacker can execute code on the first device” when “A remote code executable vulnerability exists in the software Y installed on the certain first device” and “The first device and the second device are connected in a communicable manner” and “An attacker can execute code on the second device”.

Referring to FIG. 3, it can be seen from the initial facts that “A remote code executable vulnerability exists in the software Y installed on the device B” and “The device A and the device B are connected in a communicable manner” in the system to be diagnosed. In addition, as mentioned above, it is derived that “An attacker can execute code on the device A”. In other words, it can be seen that all the conditions included in the analysis rules are satisfied. In other words, it can be seen that “An attacker can execute code on the device B”.

Therefore, the analysis unit 123 derives a new fact that “An attacker can execute code on the device B”. The analysis unit 123 also generates an attack graph that represents an attack path from the initial facts to the derived new fact.

Specifically, the analysis unit 123 connects each of the three facts to the fact representing the attack with an edge that goes from each of the two initial facts and the fact “An attacker can execute code on the device A” to the fact representing the executable attack.

The attack graph shown in FIG. 3 is generated by the above process. In other words, the attack path represents the series of flow from the initial facts to “An attacker can execute code on the device B”.

The procedure for the analysis unit 123 to generate the attack graph is not limited to the procedure described above. The analysis unit 123 may generate the attack graph based on the initial facts according to a procedure other than the procedure described above. The analysis unit 123 may analyze using another method other than those described above for requiring an attack or a flow of an attack that can be executed in the system to be diagnosed from the initial facts.

It is assumed that, depending on the system to be diagnosed, the analysis unit 123 may not be able to generate an attack graph that includes attack paths. For example, if sufficient security measures are implemented for each device of the system to be diagnosed, and there is no initial fact that represents the premise that an attack can be executed, it is assumed that an attack graph that includes meaningful attack paths cannot be generated.

Following the above procedure, the analysis unit 123 generates an attack graph. The analysis unit 123 stores information indicating the generated attack graph in the analysis result storage unit 133. The analysis result storage unit 133 has a function of storing the information indicating the attack graph.

The output unit 124 has a function of outputting the information of the attack graph stored in the analysis result storage unit 133 and other information necessary with respect to the analysis of security in the system to be diagnosed to the display unit 140 as necessary. The display unit 140 also has a function of displaying the attack graph and other information output from the output unit 124.

The display unit 140 may be a display or the like that is referred to by an administrator of an IT system in a company that is a system to be diagnosed. The display unit 140 may be another device or the like connected to the output unit 124 through a network.

As shown in FIG. 1, the fact generation unit 122, the analysis unit 123, the output unit 124, the initial fact storage unit 132, and the analysis result storage unit 133 correspond to an attack graph analysis unit that generates an attack graph that can be used to analyze attacks that may occur in the system to be diagnosed and countermeasures against the attacks from the initial facts.

[Description of Operation]

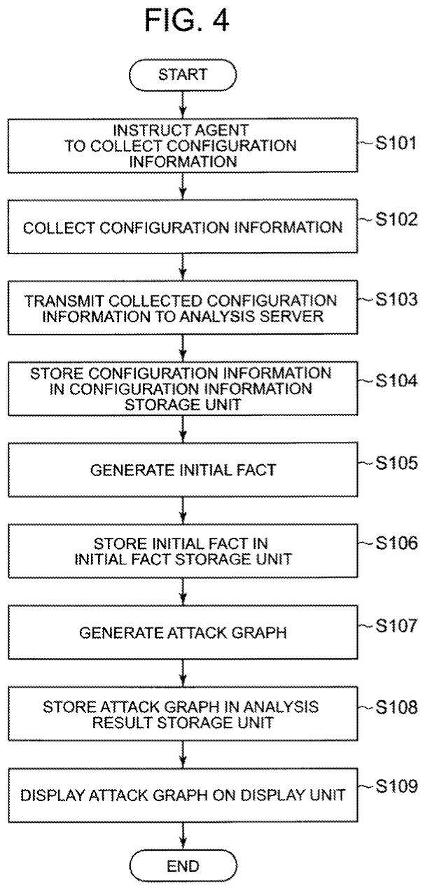

Hereinafter, the operation of displaying the attack graph of the analysis server 100 of this example embodiment will be described with reference to FIG. 4. FIG. 4 is a flowchart showing the operation of the attack graph display processing by the analysis server 100 of the first example embodiment.

First, the configuration information acquisition unit 121 instructs the agent 212, 222, respectively, to collect each configuration information of the device 210, 220 (step S101). The processing of step S101 may be omitted.

Next, the agent 212, 222 collect each configuration information by scanning inside the device 210, 220, respectively (step S102). Next, the device communication unit 213, 223 transmit the collected each configuration information to the analysis server 100, respectively (step S103).

The server communication unit 110 receives each of the transmitted configuration information and inputs each of the received configuration information to the configuration information acquisition unit 121. Next, the configuration information acquisition unit 121 stores each of the input configuration information in the configuration information storage unit 131 (step S104).

Next, the fact generation unit 122 generates an initial fact by referring to the configuration information stored in the configuration information storage unit 131 (step S105). Next, the fact generation unit 122 stores the generated initial fact in the initial fact storage unit 132 (step S106).

Next, the analysis unit 123 generates an attack graph based on the initial facts stored in the initial fact storage unit 132 (step S107). Next, the analysis unit 123 stores the generated attack graph in the analysis result storage unit 133 (step S108).

Next, the output unit 124 displays the attack graph stored in the analysis result storage unit 133 on the display unit 140 (step S109). After displaying the attack graph, the analysis server 100 ends the attack graph display processing.

[Description of Effect]

The analysis server 100 of this example embodiment generates an attack graph based on initial facts obtained from information collected by each component of the configuration management unit using an agent. By using the attack graphs and the attack paths included in the attack graphs, the analysis server 100 can analyze the possibility of an attack being executed on a device included in the system to be diagnosed, and the presence or absence of another attack that may occur on other devices when an attack is executed. Thus, the analysis server 100 of this example embodiment can analyze security problems where the configuration of the entire system to be diagnosed is taken into account.

When the system to be diagnosed is an IT system of a company, the state of the system and the devices included in the system often change frequently. For example, the state of the system may change as new devices are connected to the network, which is the system to be diagnosed, or as device software included in the system is installed or updated.

The analysis server 100 of this example embodiment can generate an attack graph that is in line with the state of the real system to be diagnosed, using information collected by agents mounted on the device scanning the device. Therefore, the analysis server 100 of this example embodiment can analyze attacks that may actually occur without deviating from the state of the real system to be diagnosed.

As a variation of the first example embodiment, the example described below is possible.

As described above, the function for acquiring information of devices in the configuration management unit of the analysis server 100 is similar to the function for acquiring information of devices possessed by an asset management system or the like described in NPL 1. Therefore, when an asset management system is operated in the system to be diagnosed, each component included in the configuration management unit of the analysis server 100 may share the function of acquiring information of devices that the asset management system has with the asset management system.

When the function of acquiring information of the devices is shared with the asset management system, the analysis server 100 may not have the components included in the configuration management unit. The analysis server 100 may then acquire from the asset management system information of the devices collected by the asset management system by having an agent of each device scan each device.

### Example Embodiment 2

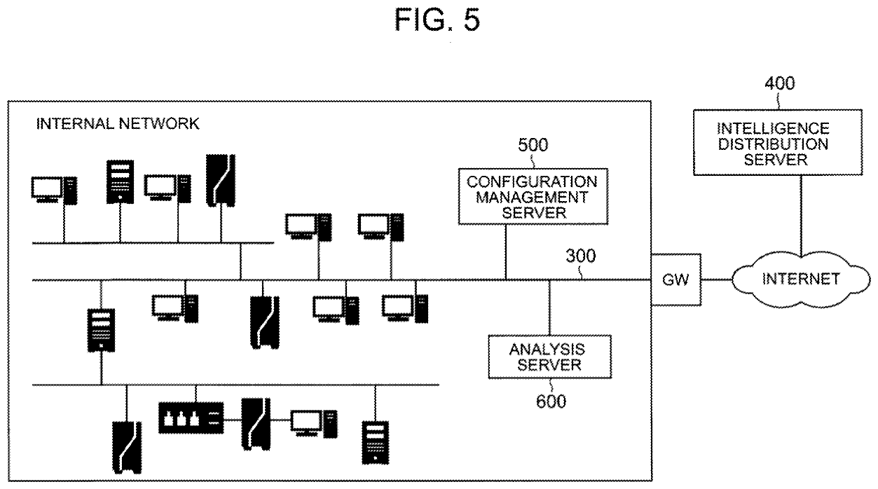

FIG. 5 is an explanatory diagram showing an example of the use of a configuration management server and an analysis server of the second example embodiment of the present invention. The communication network 300, which is a corporate network shown in FIG. 5, is, for example, an IT system in a company, and is an example of a system to be diagnosed in this example embodiment. Then, the configuration management server 500 and the analysis server 600 of this example embodiment are connected to the communication network 300.

The number of devices connected to the communication network 300 is not particularly limited, and several thousand or more devices may be connected to the communication network 300. FIG. 5 shows, as an example, a case in which a plurality of devices are connected.

As shown in FIG. 5, the corporate network is connected to the intelligence distribution server 400 through the Internet communicably. The corporate network and the Internet are connected by a gateway (GW shown in FIG. 5).

The intelligence distribution server 400 has a function of distributing intelligence information indicating the type of vulnerability, the contents of the vulnerability, and countermeasures against the vulnerability, and the like. The intelligence distribution server 400, for example, distributes intelligence information indicating the above-mentioned vulnerabilities, newly discovered vulnerabilities, and vulnerabilities whose exploitation is prevalent.

Since the vulnerability may exist in a particular version of the software, the intelligence information may be information indicating that the user is encouraged to update to a version that does not have the vulnerability.

Even if a vulnerability exists in the software, exploitation of the vulnerability may be possible only when a specific setting is made. In such a case, the intelligence information may be information indicating that the user is encouraged to change the settings so that the vulnerability cannot be exploited.

A use case different from the example shown in FIG. 5 is also possible. For example, one or both of the configuration management server 500 and the analysis server 600 may be set outside the corporate network and connected to the corporate network through a GW.

The intelligence distribution server 400 may be set inside a corporate network. The corporate network may be further divided into a plurality of segments. Various arrangements of each of the configuration management server 500, the analysis server 600, and the intelligence distribution server 400 on the network may be assumed.

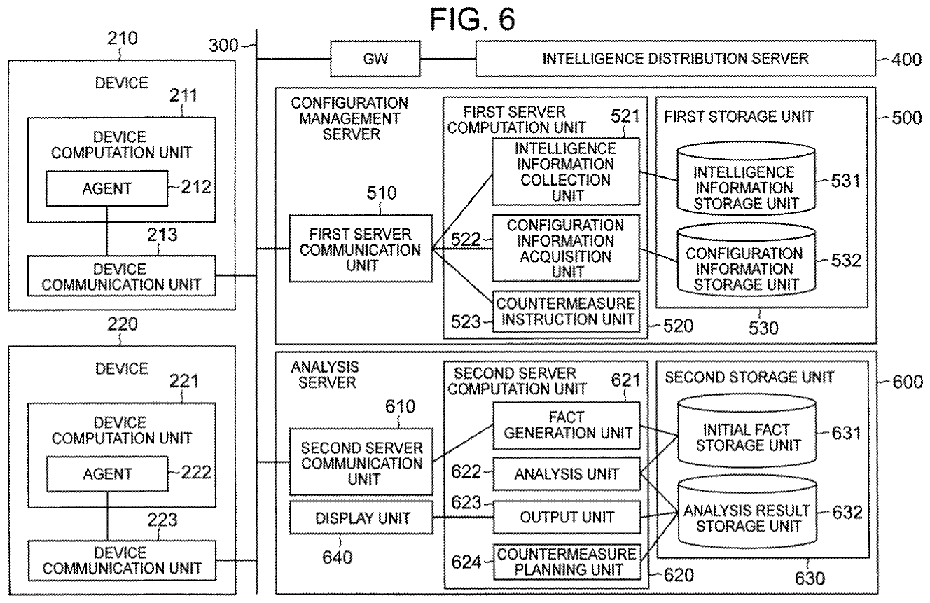

The configuration and operation of the configuration management server 500 and the analysis server 600 will be described below, respectively. FIG. 6 is a block diagram showing an example of each configuration of the configuration management server and the analysis server of the second example embodiment of the present invention. As shown in FIG. 6, the configuration management server 500 of the second example embodiment includes a first server communication unit 510, a first server computation unit 520, and a first storage unit 530.

As shown in FIG. 6, the first server computation unit 520 includes an intelligence information collection unit 521, a configuration information acquisition unit 522, and a countermeasure instruction unit 523. Also, the first storage unit 530 includes an intelligence information storage unit 531 and a configuration information storage unit 532.

As in the first example embodiment, the device 210, 220 are examples of devices included in the corporate network shown in FIG. 5, which is a system to be diagnosed. As in the first example embodiment, the number of devices included in the system to be diagnosed is not limited to the example shown in FIG. 6. The number of devices included in the system to be diagnosed is not particularly limited.

The first server communication unit 510 has a function of communicating with the device 210, 220, the intelligence distribution server 400, and the analysis server 600, respectively, through the communication network 300.

The intelligence information collection unit 521 has a function of acquiring intelligence information distributed from the intelligence distribution server 400 through the first server communication unit 510.

The intelligence information collection unit 521 stores the acquired intelligence information in the intelligence information storage unit 531. The intelligence information storage unit 531 has a function of storing the intelligence information. Note that the intelligence information collection unit 521 and the intelligence information storage unit 531 may not be included in the configuration management server 500.

The countermeasure instruction unit 523 has a function of instructing the agent 212, 222 to execute the countermeasures determined by the countermeasure planning unit 624 described below. The countermeasure instruction unit 523 transmits to the agent 212, 222 countermeasures according to the status of the respective devices.

The countermeasures are, for example, “Applying the specified patch”, “Changing the settings”, “Updating the software to a version that the vulnerability has been resolved”, and “Firewall settings”.

When the instructions to execute the countermeasures are transmitted, the agent 212, 222 automatically execute the transmitted countermeasures together with the instructions, for example. In addition, the agent 212, 222 may present the content of the transmitted countermeasures to the users of the devices, such as by displaying the content of the countermeasures on a display comprised by the device 210 or the device 220 in the form of a pop-up or the like, so that the users of each device can grasp the content. The transmitted countermeasures may be automatically executed or may be manually executed by a user of the device to which the countermeasures are presented.

The configuration information acquisition unit 522 and the configuration information storage unit 532 have substantially equivalent functions to those of the configuration information acquisition unit 121 and the configuration information storage unit 131 described in the first example embodiment, respectively.

As shown in FIG. 6, the analysis server 600 of the second example embodiment includes a second server communication unit 610, a second server computation unit 620, a second storage unit 630, and a display unit 640.

As shown in FIG. 6, the second server computation unit 620 includes a fact generation unit 621, an analysis unit 622, an output unit 623, and a countermeasure planning unit 624. In addition, the second storage unit 630 includes an initial fact storage unit 631 and an analysis result storage unit 632.

The second server communication unit 610 has a function of communicating with the configuration management server 500 through the communication network 300.

The analysis unit 622, the initial fact storage unit 631, and the analysis result storage unit 632 have substantially equivalent functions to those of the analysis unit 123, the initial fact storage unit 132, and the analysis result storage unit 133 of the first example embodiment, respectively.

The fact generation unit 621 has a function of generating one or more initial facts by referring to the configuration information stored in the configuration information storage unit 532 of the configuration management server 500 through the second server communication unit 610. Further, the fact generation unit 621 may generate the initial facts by referring to the intelligence information stored in the intelligence information storage unit 531. The fact generation unit 621 generates the one or more initial facts in the same manner as the fact generation unit 122 of the first example embodiment.

The countermeasure planning unit 624 plans security countermeasures in the system to be diagnosed using the derived attack graph. The countermeasure planning unit 624 may plan countermeasures using the intelligence information stored in the intelligence information storage unit 531 of the configuration management server 500.

If a certain attack is executable in an attack path, the executability of the attack may be resolved if the fact that is a premise for the executable attack is resolved. In other words, the possibility of the attack may be resolved when the configuration of the device related to the fact included in the attack path is modified. Therefore, the countermeasure planning unit 624 plans security countermeasures so that the configuration of the device related to the fact included in the attack path is modified.

In the following, the example shown in FIG. 3 is assumed. In the example shown in FIG. 3, the attack “An attacker can execute code on the device B” is executable if all of the initial facts represented as “Fact that contributes to achieving the attack” exist. In other words, if any of the initial facts represented as “Fact that contributes to achieving the attack” does not exist, the possibility of executing the attack “An attacker can execute code on the device B” is resolved.

Therefore, the countermeasure planning unit 624 plans security countermeasures to modify one or more of configurations related to the initial facts represented as “Fact that contributes to achieving the attack” as security countermeasures to resolve the attack “An attacker can execute code on the device B”. That is, as an example, the countermeasure planning unit 624 plans security countermeasures to execute one or more countermeasures among the following countermeasures: “Blocking the Internet connection of the device A”, “Resolving the remote code executable vulnerability of the device A”, “Blocking the communication between the device A and the device B”, and “Resolving the vulnerability of the software installed on the device B”, and the like.

As described above, by planning countermeasures using attack paths, the countermeasure planning unit 624 can plan appropriate countermeasures to prevent attacks that are executable in the system to be diagnosed.

The countermeasure planning unit 624 may plan security countermeasures to modify all configurations related to the facts included in the attack path, or may plan security countermeasures to modify some configurations among configurations related to the facts included in the attack path with priority. “Modifying some configurations with priority” means, for example, that the target configuration is modified before other configurations, or only the target configuration is modified.

When the countermeasure planning unit 624 plans security countermeasures to modify some configurations among configurations related to the facts included in the attack path, the selected configurations are assumed to be various.

For example, the countermeasure planning unit 624 may plan countermeasures to modify the configuration of the device related to the facts included in more attack paths with priority. Also, the countermeasure planning unit 624 may refer to the intelligence information stored in the intelligence information storage unit 531 as appropriate, and plan security countermeasures so as to resolve vulnerabilities that are highly urgent.

The countermeasure planning unit 624 may plan countermeasures to modify the configurations included in the attack paths related to the important devices with priority.

For example, it is assumed that the device related to the facts included in the attack path is an important device by some standard, such as when the device is a server that holds confidential information of a company. If the device is an important device, the countermeasure planning unit 624 plans security countermeasures such that the configurations related to the fact included in the attack path are modified over other configurations with priority.

The countermeasure planning unit 624 may plan security countermeasures such that countermeasures that are easy to implement are executed with priority.

In the example shown in FIG. 3, assume that the device B is an important server that runs continuously and is difficult to update its software, but does not need to communicate with the device A. It is also assumed that the above information is collected as configuration information.

In the above case, the countermeasure planning unit 624 plans a security countermeasure, for example, to “Blocking the communication between the device A and the device B”.

If the need for communication between the device A and the device B is unknown, it is difficult to easily implement the blocking the communication between the device A and the device B because it is necessary to investigate the need for communication. If the need for communication is unknown, the countermeasure planning unit 624 may select a countermeasure that, for example, “Resolving the remote code executable vulnerability of the device A”.

Alternatively, the countermeasure planning unit 624 may plan security countermeasures so as to select countermeasures that are easy to implement by the agent 212, 222 with priority.

For example, resolving vulnerabilities of the OS and software is an easy countermeasure to be implemented by agents. However, changing the connected network is a difficult countermeasure to be implemented by agents, because it may involve modification of the entire system, including modification of the hardware configuration. Therefore, the countermeasure planning unit 624 selects the resolve of vulnerabilities of the OS and software with priority over the change of the connected network.

Further, the countermeasure planning unit 624 may plan security countermeasures so that the agent 212, 222 select countermeasures that can be automatically implemented with priority.

For example, resolving a vulnerability of a certain OS is a countermeasure that requires a user to execute manually, such as rebooting the device. On the other hand, resolving a vulnerability of a certain software is a countermeasure that can be automatically executed by agent 212, 222. Therefore, the countermeasure planning unit 624 selects resolving the vulnerability of the software with priority. The resolving the vulnerability includes updating the software, changing the settings of the software, and deleting the software, and the like.

When the countermeasure planning unit 624 generates the countermeasure plan, it transmits the generated countermeasure plan to the countermeasure instruction unit 523 through the second server communication unit 610. As described earlier, the countermeasure instruction unit 523 transmits, together with the countermeasure, an instruction to execute the countermeasure to each of the devices included in the system to be diagnosed.

The output unit 624 outputs to the display unit 640 information of the attack graph stored in the analysis result storage unit 633, security countermeasures planned by the countermeasure planning unit 624, or other information necessary with respect to analysis of security in the system to be diagnosed.

The display unit 640, like the display unit 140, has a function of displaying information output from the output unit 624. The display unit 640 may be a display or the like that is referred to by an administrator of an IT system in a company that is a system to be diagnosed. The display unit 640 may be another device or the like connected to the output unit 624 through a network.

[Description of Operation]

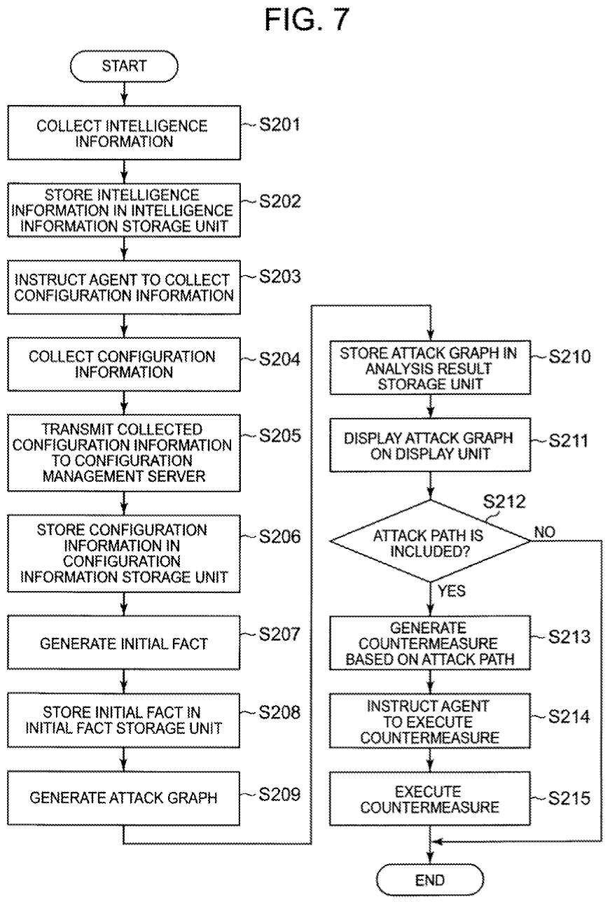

Hereinafter, the operation of instructing countermeasures by the configuration management server 500 and the analysis server 600 of this example embodiment will be described with reference to FIG. 7. FIG. 7 is a flowchart showing the operation of the countermeasure instruction processing by the configuration management server 500 and the analysis server 600 of the second example embodiment.

First, the intelligence information collection unit 521 acquires intelligence information distributed from the intelligence distribution server 400 through the first server communication unit 510 (step S201).

Next, the intelligence information collection unit 521 stores the acquired intelligence information in the intelligence information storage unit 531 (step S202).

Next, the configuration information acquisition unit 522 instructs the agent 212, 222 to collect each configuration information of the device 210, 220, respectively (step S203). The processing of steps S201 to S203 may be omitted.

Next, the agent 212, 222 collect each configuration information by scanning inside the device 210, 220, respectively (step S204). Next, the device communication unit 213, 223 transmit the collected each configuration information to the configuration management server 500, respectively (step S205).

The first server communication unit 510 receives each of the transmitted configuration information and inputs each of the received configuration information to the configuration information acquisition unit 522. Next, the configuration information acquisition unit 522 stores each of the input configuration information in the configuration information storage unit 532 (step S206).

Next, the fact generation unit 621 refers to the configuration information stored in the configuration information storage unit 532 of the configuration management server 500 through the second server communication unit 610 and generates an initial fact (step S207). In generating the initial fact, the fact generation unit 621 may refer to the intelligence information stored in the intelligence information storage unit 531.

Next, the fact generation unit 621 stores the generated initial fact in the initial fact storage unit 631 (step S208).

Next, the analysis unit 622 generates an attack graph based on the initial facts stored in the initial fact storage unit 631 (step S209). Next, the analysis unit 622 stores the generated attack graph in the analysis result storage unit 632 (step S210).

Next, the output unit 623 displays the attack graph stored in the analysis result storage unit 632 on the display unit 640 (step S211).

Next, the countermeasure planning unit 624 confirms whether or not the displayed attack graph includes an attack path (step S212). If the attack path is not included (No in step S212), the configuration management server 500 and the analysis server 600 end the countermeasure instruction processing.

If the attack path is included (Yes in step S212), the countermeasure planning unit 624 generates a countermeasure based on the derived attack path (step S213). Next, the countermeasure planning unit 624 transmits the generated countermeasure to the countermeasure instruction unit 523 through the second server communication unit 610.

Next, the countermeasure instruction unit 523 instructs the agent 212, 222, respectively, to execute the countermeasures transmitted from the countermeasure planning unit 624 (step S214). The countermeasures are transmitted from the countermeasure instruction unit 523 to the agent 212, 222 together with the instructions.

Next, the agent 212, 222 execute the transmitted countermeasures, respectively (step S215). After the countermeasures have been executed, the configuration management server 500 and the analysis server 600 end the countermeasure instruction processing.

[Description of Effect]

The analysis server 600 of this example embodiment produces the same effects as those produced by the analysis server 100 described in the first example embodiment. Furthermore, the analysis server 600 can plan security countermeasures in the system to be diagnosed based on the attack graph and the attack path included in the attack graph.

In the configuration management system and the like described in NPL 1, in general, the existence of vulnerabilities is determined and countermeasures are planned for each device included in the system to be diagnosed. The analysis server 600 of this example embodiment, while cooperating with the configuration management server 500, plans security countermeasures using an attack graph as described above.

In other words, as described above, the analysis server 600 of this example embodiment can analyze the possibility of an attack being executed on a device included in the system to be diagnosed, the existence of another attack that may occur on another device if an attack is executed, the range of influence if an attack is executed on a certain device, and the like. When the analysis server 600 is used, in addition to the security countermeasures generated by the configuration management system and the like described in NPL 1, security measures can be generated in which the configuration and impact of the entire system to be diagnosed are taken into account.

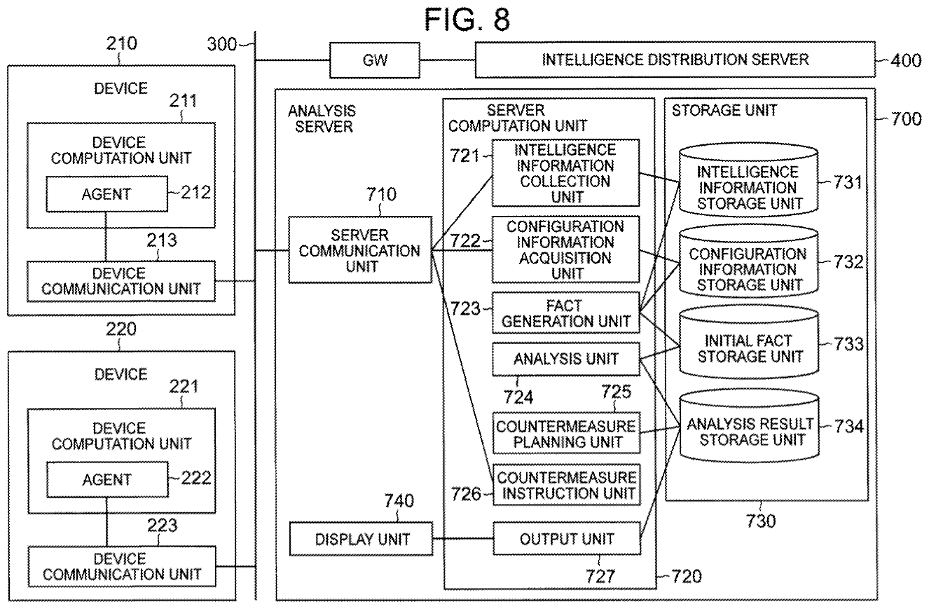

Hereinafter, a variation of this example embodiment is described. FIG. 8 is a block diagram showing another example of the configuration of the analysis server of the second example embodiment of the present invention. As shown in FIG. 8, the analysis server 700 of the second example embodiment includes a server communication unit 710, a server computation unit 720, a storage unit 730, and a display unit 740.

The server communication unit 710 has a function of communicating with the device 210, 220, and the intelligence distribution server 400, respectively, through the communication network 300.

As shown in FIG. 8, the server computation unit 720 includes an intelligence information collection unit 721, a configuration information acquisition unit 722, a fact generation unit 723, an analysis unit 724, a countermeasure planning unit 725, a countermeasure instruction unit 726, and an output unit 727.

Each of the functions possessed by the intelligence information collection unit 721, the configuration information acquisition unit 722, the fact generation unit 723, the analysis unit 724, the countermeasure planning unit 725, the countermeasure instruction unit 726, and the output unit 727 is the same as each of the functions possessed by the intelligence information collection unit 521, the configuration information acquisition unit 522, the fact generation unit 621, the analysis unit 622, the countermeasure planning unit 624, countermeasure instruction unit 523, and output unit 623, respectively.

As shown in FIG. 8, the storage unit 730 includes an intelligence information storage unit 731, a configuration information storage unit 732, an initial fact storage unit 733, and an analysis result storage unit 734.

Each of the functions possessed by the intelligence information storage unit 731, the configuration information storage unit 732, the initial fact storage unit 733, and the analysis result storage unit 734 is the same as each of the functions possessed by the intelligence information storage unit 531, the configuration information storage unit 532, the initial fact storage unit 631, and the analysis result storage unit 632, respectively. In addition, the function possessed by the display unit 740 are the same as that possessed by the display unit 640.

That is, the configuration management server 500 and the analysis server 600 shown in FIG. 6 may be realized in a single system, such as the analysis server 700 shown in FIG. 8.

Further, the analysis server 700 may have the function possessed by the intelligence distribution server 400. In other words, the intelligence distribution server 400, the configuration management server 500, and the analysis server 600 may be realized in a single system.

In either case, the analysis server 700 may be set inside the network that is the system to be diagnosed, and may be set outside the network that is the system to be diagnosed and be connected to the system to be diagnosed through a WAN (Wide Area Network). Further, some or all of each of the functions of the configuration management server 500, the analysis server 600, or the analysis server 700 may be provided in the form of cloud computing.

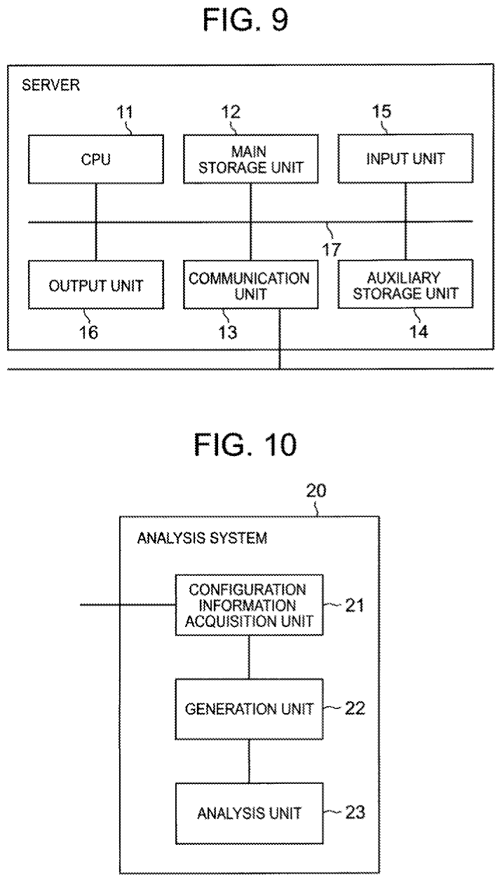

A specific example of a hardware configuration of the server according to each example embodiment will be described below. FIG. 9 is an explanatory diagram showing an example of a hardware configuration of the server according to the present invention. The server shown in FIG. 9 corresponds to any of the analysis server 100 of the first example embodiment, the configuration management server 500 of the second example embodiment, the analysis server 600, and the analysis server 700.

The server shown in FIG. 9 includes a CPU 11, a main storage unit 12, a communication unit 13, and an auxiliary storage unit 14. The server also includes an input unit 15 for the user to operate and an output unit 16 for presenting a processing result or a progress of the processing contents to the user.

The analysis server 100, the configuration management server 500, the analysis server 600, and the analysis server 700 are realized by software, as an example, by the CPU 11 shown in FIG. 9 executing a program that provides the functions possessed by each component.

Specifically, each function is realized by software as the CPU 11 loads the program stored in the auxiliary storage unit 14 into the main storage unit 12 and executes it to control the operation of the analysis server 100, the configuration management server 500, the analysis server 600, or the analysis server 700.

The main storage unit 12 is used as a work area for data and a temporary save area for data. The main storage unit 12 is, for example, RAM (Random Access Memory). The storage unit 130, the first storage unit 530, the second storage unit 630, and the storage unit 730 are realized by the main storage unit 12.

The communication unit 13 has a function of inputting and outputting data to and from peripheral devices through a wired network or a wireless network (information communication network). The server communication unit 110, the first server communication unit 510, the second server communication unit 610, and the server communication unit 710 are realized by the communication unit 13.

The auxiliary storage unit 14 is a non-transitory tangible medium. Examples of non-transitory tangible media are, for example, a magnetic disk, an optical magnetic disk, a CD-ROM (Compact Disk Read Only Memory), a DVD-ROM (Digital Versatile Disk Read Only Memory), a semiconductor memory.

The input unit 15 has a function of inputting data and processing instructions. The input unit 15 is, for example, an input device such as a keyboard or a mouse.

The output unit 16 has a function of outputting data. The output unit 16 is, for example, a display device such as a liquid crystal display device. The display unit 140, the display unit 640, and the display unit 740 are realized by the output unit 16.

As shown in FIG. 9, in the server, each component is connected to the system bus 17.

The auxiliary storage unit 14 stores, for example, programs for realizing the configuration information acquisition unit 121, the fact generation unit 122, the analysis unit 123, and the output unit 124 in the first example embodiment.

The auxiliary storage unit 14 stores, for example, programs for realizing the intelligence information collection unit 521, the configuration information acquisition unit 522, and the countermeasure instruction unit 523 in the configuration management server 500 of the second example embodiment.

The auxiliary storage unit 14 stores, for example, programs for realizing the fact generation unit 621, the analysis unit 622, the output unit 623, and the countermeasure planning unit 624 in the analysis server 600 of the second example embodiment.

The auxiliary storage unit 14 stores, for example, programs for realizing the intelligence information collection unit 721, the configuration information acquisition unit 722, the fact generation unit 723, the analysis unit 724, the countermeasure planning unit 725, the countermeasure instruction unit 726, and the output unit 727 in the variation of the second example embodiment.

There are various variations of the realization method of each server described above. For example, each server may be realized by any combination of a separate information processing device and a program for each component. Also, a plurality of components comprised by each device may be realized by any combination of a single information processing device and a program.

Some or all of the components may be realized by a general-purpose circuit (circuitry) or a dedicated circuit, a processor, or a combination of these. They may be configured by a single chip or by multiple chips connected via a bus. Some or all of the components may be realized by a combination of the above-mentioned circuit, etc. and a program.

In the case where some or all of the components are realized by a plurality of information processing devices, circuits, or the like, the plurality of information processing devices, circuits, or the like may be centrally located or distributed. For example, the information processing devices, circuits, etc. may be realized as a client-server system, a cloud computing system, etc., each of which is connected via a communication network.

Next, an overview of the present invention will be explained. FIG. 10 is a block diagram showing an overview of an analysis system according to the present invention. The analysis system 20 according to the present invention includes a configuration information acquisition unit 21 (for example, the configuration information acquisition unit 121) which acquires configuration information from an agent which collects the configuration information of a device by scanning the device included in a system to be diagnosed; a generation unit 22 (for example, the fact generation unit 122) which generates one or more initial facts which indicates a situation relating to security in the system to be diagnosed or the device based on the configuration information; and an analysis unit 23 (for example, the analysis unit 123) which analyzes a flow of an attack which is executable in the system to be diagnosed based on the one or more initial facts.

With such a configuration, the analysis system can analyze security problems where the configuration of the entire system to be diagnosed is taken into account.

While the present invention has been explained with reference to the example embodiments and examples, the present invention is not limited to the aforementioned example embodiments and examples. Various changes understandable to those skilled in the art within the scope of the present invention can be made to the structures and details of the present invention.

Some or all of the aforementioned example embodiment can be described as supplementary notes mentioned below, but are not limited to the following supplementary notes.

(Supplementary note 1) An analysis system comprising: a configuration information acquisition unit which acquires configuration information from an agent which collects the configuration information of a device by scanning the device included in a system to be diagnosed; a generation unit which generates one or more initial facts which indicates a situation relating to security in the system to be diagnosed or the device based on the configuration information; and an analysis unit which analyzes a flow of an attack which is executable in the system to be diagnosed based on the one or more initial facts.

(Supplementary note 2) The analysis system according to Supplementary note 1, wherein the analysis unit analyzes the flow of the attack which is executable based on the initial facts and an analysis rule.

(Supplementary note 3) The analysis system according to Supplementary note 1 or 2, wherein the analysis unit analyzes the flow of the attack which is executable by generating an attack graph that can represent the flow of the attack.

(Supplementary note 4) The analysis system according to any one of Supplementary notes 1 to 3, further comprising: a countermeasure planning unit which plans a countermeasure against the analyzed flow of the attack; and a countermeasure instruction unit which instructs the device to execute the planned countermeasure.

(Supplementary note 5) The analysis system according to Supplementary note 4, wherein the countermeasure planning unit plans the countermeasure that modify one or more configurations that are related to the initial facts among the configurations of the device.

(Supplementary note 6) The analysis system according to Supplementary note 4 or 5, further including: a configuration management server having the configuration information acquisition unit and the countermeasure instruction unit; and an analysis server having the generation unit, the analysis unit, and the countermeasure planning unit.

(Supplementary note 7) The analysis system according to any one of Supplementary notes 1 to 6, wherein the generation unit generates the initial facts based on the information about the vulnerability.

(Supplementary note 8) The analysis system according to any one of Supplementary notes 1 to 7, wherein the analysis unit analyzes the new flow of the attack that result from the analyzed flow of the attack.

(Supplementary note 9) An analysis method comprising: acquiring configuration information from an agent which collects the configuration information of a device by scanning the device included in a system to be diagnosed; generating one or more initial facts which indicates a situation relating to security in the system to be diagnosed or the device based on the configuration information; and analyzing a flow of an attack which is executable in the system to be diagnosed based on the one or more initial facts.

(Supplementary note 10) An analysis program causing a computer to execute: an acquisition process of acquiring configuration information from an agent which collects the configuration information of a device by scanning the device included in a system to be diagnosed; a generation process of generating one or more initial facts which indicates a situation relating to security in the system to be diagnosed or the device based on the configuration information; and an analysis process of analyzing a flow of an attack which is executable in the system to be diagnosed based on the one or more initial facts.

### REFERENCE SIGNS LIST

11 CPU
12 Main storage unit
13 Communication unit
14 Auxiliary storage unit
15 Input unit
16 Output unit
17 System bus
20 Analysis system
21, 121, 522, 722 Configuration information acquisition unit
22 Generation unit
23, 123, 622, 724 Analysis unit
100, 600, 700 Analysis server
110, 710 Server communication unit
120, 720 Server computation unit
122, 621, 723 Fact generation unit
124, 623, 727 Output unit
130, 730 Storage unit
131, 532, 732 Configuration information storage unit
132, 631, 733 Initial fact storage unit
133, 632, 734 Analysis result storage unit
140, 640, 740 Display unit
210, 220 Device
211, 221 Device computation unit
212, 222 Agent
213, 223 Device communication unit
300 Communication network
400 Intelligence distribution server
500 Configuration management server
510 First server communication unit
520 First server computation unit
521, 721 Intelligence information collection unit
523, 726 Countermeasure instruction unit
530 First storage unit
531, 731 Intelligence information storage unit
610 Second server communication unit
620 Second server computation unit
624, 725 Countermeasure planning unit
630 Second storage unit

What is claimed is:

1. An analysis system comprising:
a configuration information acquisition unit which acquires configuration information from an agent which collects the configuration information of a device by scanning the device included in a system to be diagnosed;
a generation unit which generates one or more initial facts which indicates a situation relating to security in the system to be diagnosed or the device based on the configuration information; and
an analysis unit which analyzes a flow of an attack which is executable in the system to be diagnosed based on the one or more initial facts.

2. The analysis system according to claim 1, wherein
the analysis unit analyzes the flow of the attack which is executable based on the initial facts and an analysis rule.

3. The analysis system according to claim 1, wherein
the analysis unit analyzes the flow of the attack which is executable by generating an attack graph that can represent the flow of the attack.

4. The analysis system according to claim 1, further comprising:
a countermeasure planning unit which plans a countermeasure against the analyzed flow of the attack; and
a countermeasure instruction unit which instructs the device to execute the planned countermeasure.

5. The analysis system according to claim 4, wherein
the countermeasure planning unit plans the countermeasure that modify one or more configurations that are related to the initial facts among the configurations of the device.

6. The analysis system according to claim 4, further including:
a configuration management server having the configuration information acquisition unit and the countermeasure instruction unit; and
an analysis server having the generation unit, the analysis unit, and the countermeasure planning unit.

7. The analysis system according to claim 1, wherein
the generation unit generates the initial facts based on the information about the vulnerability.

8. The analysis system according to claim 1, wherein
the analysis unit analyzes the new flow of the attack that result from the analyzed flow of the attack.

9. An analysis method comprising:
acquiring configuration information from an agent which collects the configuration information of a device by scanning the device included in a system to be diagnosed;
generating one or more initial facts which indicates a situation relating to security in the system to be diagnosed or the device based on the configuration information; and
analyzing a flow of an attack which is executable in the system to be diagnosed based on the one or more initial facts.

10. A non-transitory computer-readable recording medium recording an analysis program causing a computer to execute:
an acquisition process of acquiring configuration information from an agent which collects the configuration information of a device by scanning the device included in a system to be diagnosed;
a generation process of generating one or more initial facts which indicates a situation relating to security in the system to be diagnosed or the device based on the configuration information; and
an analysis process of analyzing a flow of an attack which is executable in the system to be diagnosed based on the one or more initial facts.

11. The analysis system according to claim 2, wherein
the analysis unit analyzes the flow of the attack which is executable by generating an attack graph that can represent the flow of the attack.

12. The analysis system according to claim 2, further comprising:
a countermeasure planning unit which plans a countermeasure against the analyzed flow of the attack; and
a countermeasure instruction unit which instructs the device to execute the planned countermeasure.

13. The analysis system according to claim 3, further comprising:
a countermeasure planning unit which plans a countermeasure against the analyzed flow of the attack; and
a countermeasure instruction unit which instructs the device to execute the planned countermeasure.

14. The analysis system according to claim 11, further comprising:
a countermeasure planning unit which plans a countermeasure against the analyzed flow of the attack; and
a countermeasure instruction unit which instructs the device to execute the planned countermeasure.

15. The analysis system according to claim 12, wherein
the countermeasure planning unit plans the countermeasure that modify one or more configurations that are related to the initial facts among the configurations of the device.

16. The analysis system according to claim 13, wherein
the countermeasure planning unit plans the countermeasure that modify one or more configurations that are related to the initial facts among the configurations of the device.

17. The analysis system according to claim 14, wherein
the countermeasure planning unit plans the countermeasure that modify one or more configurations that are related to the initial facts among the configurations of the device.

18. The analysis system according to claim 5, further including:
a configuration management server having the configuration information acquisition unit and the countermeasure instruction unit; and
an analysis server having the generation unit, the analysis unit, and the countermeasure planning unit.

19. The analysis system according to claim 15, further including:
a configuration management server having the configuration information acquisition unit and the countermeasure instruction unit; and
an analysis server having the generation unit, the analysis unit, and the countermeasure planning unit.

20. The analysis system according to claim 16, further including:
a configuration management server having the configuration information acquisition unit and the countermeasure instruction unit; and
an analysis server having the generation unit, the analysis unit, and the countermeasure planning unit.
